(19) United States
(12) Patent Application Publication
(10) Pub. No.: US 2025/0079431 A1
(43) Pub. Date: Mar. 6, 2025

(54) ELECTRODE MANUFACTURING METHOD

(71) Applicant: TOYOTA JIDOSHA KABUSHIKI KAISHA, Toyota-shi (JP)

(72) Inventors: Yosuke SHIMURA, Toyota-shi (JP); Tomoya MESUDA, Toyota-shi (JP)

(73) Assignee: TOYOTA JIDOSHA KABUSHIKI KAISHA, Toyota-shi (JP)

(21) Appl. No.: 18/679,545

(22) Filed: May 31, 2024

(30) Foreign Application Priority Data
Aug. 30, 2023 (JP) 2023-139444

(51) Int. Cl. H01M 4/04; H01M 4/02; H01M 4/66

(52) U.S. Cl. CPC H01M 4/0404; H01M 2004/021; H01M 4/662

(57) ABSTRACT

A coating step of coating a slurry obtained by dispersing an electrode material on a current collector foil in a solvent to obtain a coating film, and a drying step of drying the coating film while transporting the current collector foil on which the coating film is formed in a drying furnace, the coating film, three regions divided along the transport direction, a central portion disposed in the center of the width direction, and an end portion disposed on both sides of the central portion, respectively, a drying step drying each end portion of the coating film by a heat source of low energy density, drying the central portion of the coating film by a high energy density heat source, an electrode manufacturing method.

### CROSS-REFERENCE TO RELATED APPLICATION

This application claims priority to Japanese Patent Application No. 2023-139444 filed on Aug. 30, 2023 incorporated herein by reference in its entirety.

### BACKGROUND

### 1. Technical Field

The present application relates to an electrode manufacturing method.

### 2. Description of Related Art

Conventionally, there has been known an electrode manufacturing method in which slurry obtained by dispersing an electrode material in a solvent is applied onto a current collector foil to obtain a coating film and then the coating film is dried in a drying furnace to obtain an electrode.

For example, Japanese Unexamined Patent Application Publication No. 2013-084383 (JP 2013-084383 A) discloses an electrode manufacturing method in which slurry for forming an electrode mixture layer is applied to a web-shaped current collector foil and then a coating film is dried by blowing hot air to the coating film while feeding the current collector foil to which the slurry has been applied in one direction in a drying furnace.

### SUMMARY

The film thickness of an end portion of the coating film formed on the current collector foil is thinner than that of a center portion because of dripping due to surface tension. In this case, the end portion of the coating film is dried more easily than the center portion of the coating film. Therefore, the end portion of the electrode obtained by drying the coating film is easily peeled off from the current collector foil, and the battery performance may be deteriorated.

Thus, a main object of the present disclosure is to provide an electrode manufacturing method capable of suppressing peeling of an electrode from a current collector foil.

The present disclosure provides at least the following aspects.

A first aspect provides an electrode manufacturing method including: an application step of applying slurry obtained by dispersing an electrode material in a solvent onto a current collector foil to obtain a coating film; and
a drying step of drying the coating film while transporting the current collector foil on which the coating film has been formed in a drying furnace, in which:
the coating film has three regions divided along a transport direction, including a center portion disposed in a center in a width direction and end portions disposed on both sides of the center portion; and
the drying step includes drying each of the end portions of the coating film using a heat source having a low energy density, and drying the center portion of the coating film using a heat source having a high energy density.

A second aspect provides the electrode manufacturing method according to the first aspect, in which the drying step includes using hot air or a laser as the heat source having a low energy density, and using a laser as the heat source having a high energy density. A third aspect provides the electrode manufacturing method according to the second aspect, in which when a total of average energy densities of heat sources applied to the center portion of the coating film is EC and a total of average energy densities of heat sources applied to the end portions of the coating film is EE, EC/EE calculated based on the following equations is 1 or more and 4 or less.

(Laser average energy density (W/cm²))=(laser energy density (W/cm²))÷(length of laser irradiation in transport direction (mm))×(overall length of drying furnace in transport direction (mm))

(Hot air average energy density (W/cm²))=(laser average energy density (W/cm²))×(time for which coating film is dried with laser alone (s))÷(time for which coating film is dried with hot air alone (s))

A fourth aspect provides the electrode manufacturing method according to any one of the first to third aspects, in which the end portions of the coating film are each an area that extends for 3 to 18 mm from a start point toward an inner side in the width direction, the start point being an extreme end portion of the coating film in the width direction.

A fifth aspect provides the electrode manufacturing method according to any one of the first to fourth aspects, in which a length of the coating film in the width direction is 1000 mm or more and 1500 mm or less.

A battery manufacturing method includes: an electrode fabrication step of obtaining an electrode using the electrode manufacturing method according to any one of the first to fifth aspects; and a battery fabrication step of assembling a battery using the electrode.

With the electrode manufacturing method according to the present disclosure, it is possible to suppress peeling of an electrode from a current collector foil. With the battery manufacturing method according to the present disclosure, in addition, it is possible to suppress deterioration in battery performance due to peeling of an electrode.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view of a drying furnace 30 taken along a transport direction X of a current collector foil 10;

FIG. 2 is a plan view of the coating 20;

FIG. 3 is a side view of the coating 20;

FIG. 4A is a schematic showing the pulsed radiation applied to the X-direction;

FIG. 4B is a schematic diagram of a series of irradiations in the X-direction;

FIG. 5 is a schematic diagram of a heat source device 132, which is an example of the heat source device 32;

FIG. 6 is a schematic diagram of a heat source device 232, which is an example of the heat source device 32;

FIG. 7 is an experimental result showing the relationship between the range of the end portion of the coating film and the dry residual moisture;

FIG. 8 is a graph showing the relationship between the position of the coating film and the duration of drying; and

FIG. 9 is an experimental result showing a laser energy density map.

### DETAILED DESCRIPTION OF EMBODIMENTS

### An Electrode Manufacturing Method

An electrode manufacturing method of the present disclosure will be described using an embodiment.

An electrode manufacturing method according to an embodiment includes a coating step of coating a slurry obtained by dispersing an electrode material in a solvent on a current collector foil 10 to obtain a coating film 20, and a drying step of drying the coating film 20 while transporting the current collector foil 10 on which the coating film 20 is formed in a drying furnace 30.

### Coating Process

The coating step is a step of coating a slurry obtained by dispersing an electrode material in a solvent on the current collector foil 10 to obtain a coating film 20. Such coating processes are known. Exemplary examples are described below, but are not limited to this form.

The current collector foil 10 is not particularly limited as long as it is a sheet-like conductive member. For example, the current collector foil 10 may be a metal foil made of a metal such as stainless steel, copper, aluminum, titanium, or nickel. The metal foil may be made of an alloy containing two or more of these metals. The metal foil may be subjected to a surface treatment such as plating. The current collector foil 10 may be made of two or more metal foils. In this case, the metal foil may be bonded by an adhesive or the like, or may be bonded by a press or the like.

The electrode material includes at least an active material. The active material is a positive electrode active material or a negative electrode active material. The positive electrode active material is not particularly limited, and may be appropriately selected from known materials according to the desired battery performance. Examples thereof include composite oxides, metallic lithium, and sulfur. Compositions of the composite oxide include, for example, at least one of iron, manganese, titanium, nickel, cobalt, and aluminum, and lithium. Exemplary complex oxides include olivine-type lithium ferric phosphate (LiFePO₄). The negative electrode active material is not particularly limited, and may be appropriately selected from known materials depending on the desired battery performance. Examples thereof include carbon such as graphite, artificial graphite, highly oriented graphite, mesocarbon microbeads, hard carbon, and soft carbon, a metal compound, an element alloyable with lithium or a compound thereof, and boron-added carbon. Examples of elements that can be alloyed with lithium include silicon and tin.

When the electrode material includes a positive electrode active material, the electrode finally obtained becomes a positive electrode. Conversely, if the electrode material comprises a negative electrode material, the resulting electrode will be a negative electrode.

The electrode material may optionally include a conductive aid. The conductive auxiliary agent is not particularly limited, and may be appropriately selected from known materials depending on the desired battery performance. Examples thereof include acetylene black, carbon black, and graphite.

The electrode material may optionally comprise a binder. The binder is not particularly limited, and may be appropriately selected from known materials depending on the desired battery performance. Examples thereof include fluorine-containing resins such as polyvinylidene fluoride, polytetrafluoroethylene, and fluorine rubber, thermoplastic resins such as polypropylene and polyethylene, imide resins such as polyimide and polyamideimide, alkoxysilyl group-containing resins, acrylic resins such as poly(meth)acrylic acid, alginates such Is styrene-butadiene rubber (SBR), carboxymethylcellulose, sodium alginate, and ammonium alginate, water-soluble cellulose ester crosslinked products, and starch-acrylic acid graft polymers.

The electrode material may optionally comprise a solid electrolyte. The solid electrolyte is not particularly limited, and may be appropriately selected from known materials depending on the desired battery performance. Examples thereof include an oxide solid electrolyte and a sulfide solid electrolyte.

The solvent is not particularly limited as long as the electrode material can be appropriately dispersed. Examples thereof include water and an organic solvent. Examples of the organic solvents include N-methyl-2-pyrrolidone, dimethylformamide, dimethylacetamide, methanol, acetone, methyl ethyl ketone, methyl isobutyl ketone, cyclohexanone, methyl acetate, ethyl acetate, and tetrahydrofuran. One of these solvents may be used alone, or two or more of them may be used in combination.

The coating method is not particularly limited as long as the slurry can be applied to the current collector foil 10 in a thin film form. For example, the slurry can be applied to the current collector foil 10 at any thickness using a known coating apparatus.

### Drying Process

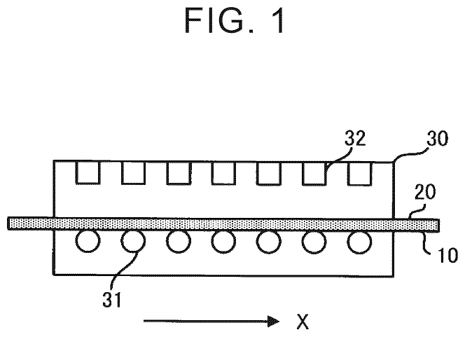

The drying step is a step of drying the coating film 20 while transporting the current collector foil 10 on which the coating film 20 is formed inside the drying furnace 30. An electrode is obtained by a drying step. FIG. 1 is a schematic diagram illustrating a drying step. FIG. 1 is a cross-sectional view of a drying furnace 30 taken along a transport direction X of a current collector foil 10.

As shown in FIG. 1, the current collector foil 10 on which the coating film is formed is transported by using a plurality of transport rollers 31 installed inside the drying furnace 30. At this time, the coating film 20 is dried by the heat source device 32 installed on the top of the coating film 20. The plurality of heat source devices 32 are typically disposed along the transport direction of the current collector foil 10. The transportation rate is not particularly limited, but is, for example, 1 to 10 m/seconds.

The heat source device 32 is a device that irradiates the coating film 20 with a heat source. In FIG. 1, since the plurality of heat source devices 32 are installed in the drying furnace 30, the coating film 20 is irradiated with the heat source a plurality of times. However, the number of the heat source devices 32 may be appropriately changed according to the purpose, and may be at least one. That is, in the drying step, the coating film 20 may be irradiated with the heat source at least once.

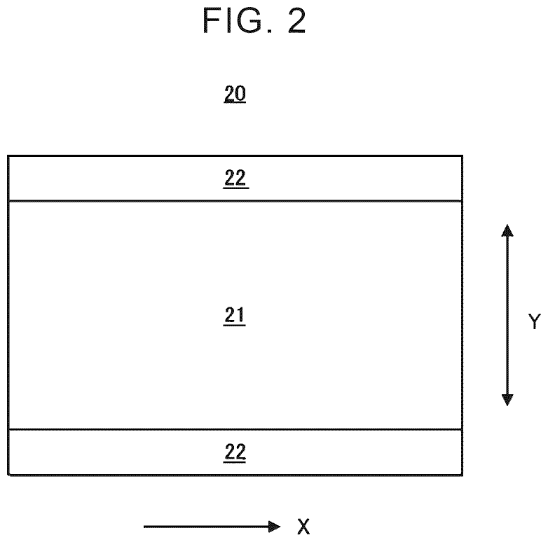

Here, the coating film 20 formed on the current collector foil 10 is divided into three regions for convenience. FIG. 2 is a plan view of the coating film 20. As shown in FIG. 2, the coating film 20 has three regions divided along the transport direction X, a central portion 21 disposed at the center in the width direction Y, and end portions 22 disposed on both sides of the central portion 21. The width direction Y is a plane direction of the coating film 20 and is a direction orthogonal to the transport direction. The reason for dividing the coating film 20 into three regions as described above is as follows.

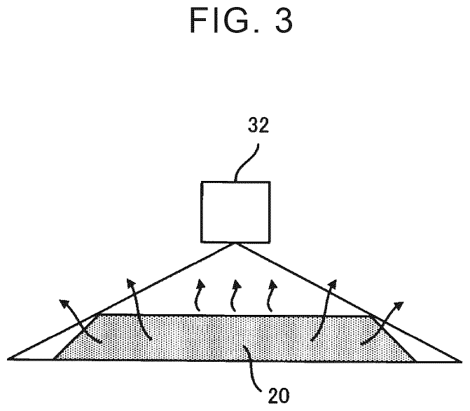

FIG. 3 shows a side view of the coating film 20. The film thickness of the end portion 22 of the coating film 20 formed on the current collector foil 10 is thinner than that of the central portion 21 due to dripping due to surface tension. Then, the end portion 22 of the coating film 20 is more likely to be dried than the central portion 21 of the coating film 20. Further, since drying proceeds from the side surface of the coating film 20, also from this point of view, the end portion 22 of the coating film 20 is more likely to be dried than the central portion 21 of the coating film 20. Therefore, the end portion of the electrode obtained by drying the coating film 20 is easily peeled off from the current collector foil 10, and the battery performance may be deteriorated. This problem becomes more pronounced when a laser is used as a heat source.

In order to solve such a problem, the drying step of one embodiment is characterized in that each end portion 22 of the coating film 20 is dried by a heat source having a low energy density, and the central portion 21 of the coating film 20 is dried by a heat source having a high energy density.

As a result, the drying time of each of the end portions 22 and the central portion 21 can be adjusted to be the same, and the end portions of the obtained electrodes can be suppressed from being peeled off from the current collector foil 10. “Same drying time” means that the drying completion time of the central portion 21 and each end portion 22 of the coating film 20 is the same in the drying furnace 30, but this does not mean that they are completely simultaneous, but means that they have a predetermined time width. Further, by making the drying time of the central portion 21 and the respective end portions 22 of the coating film 20 the same, there is an advantage that high-speed drying can be performed while the equipment is reduced. Further, the amount of the binder added in the electrode material can be reduced, and the battery performance can also be improved.

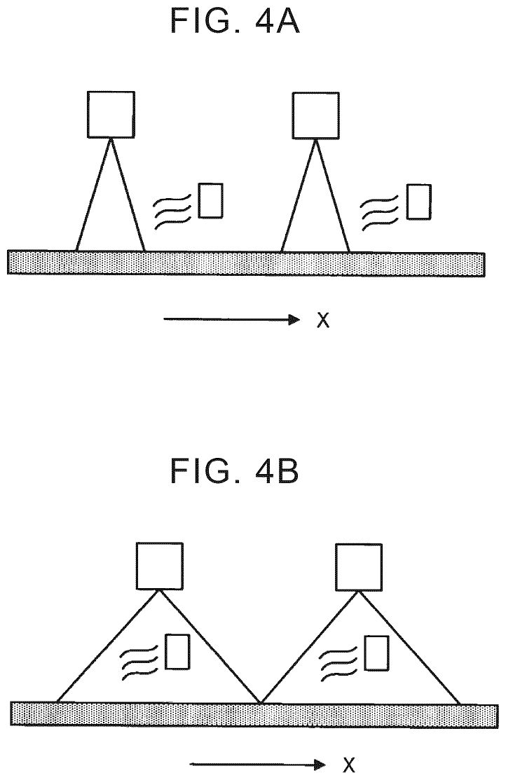

A heat source having a high energy density is a heat source having a mean energy density of 1 W/cm² or more. For example, a laser. Specific examples of the laser include a solid-state laser, a direct laser, and a VCSEL laser. The laser may be a laser having a high focusing property. Further, the irradiation frequency of the laser may be pulse irradiation or continuous irradiation with respect to the transport direction. For reference, a schematic diagram in which pulsed irradiation is performed in the transport direction X in FIG. 4A and a schematic diagram in which continuous irradiation is performed in the transport direction X in FIG. 4B are shown.

A low energy density heat source is a heat source that has a lower average energy density than a high energy density heat source. For example, a heat source having a mean energy-density of less than 1 W/cm². For example, hot air or a laser. The temperature of the hot air is not particularly limited, but is, for example, in the range of 100° C. to 120° C. The wind speed of the hot air is not particularly limited, but is, for example, greater than or equal to 3 m/s and less than or equal to 50 m/s. The hot air may be applied only to the respective end portions 22, but may be applied to the entire coating film 20. By irradiating hot air, a large amount of gaseous solvent generated in the drying furnace 30 can be discharged to the outside of the furnace. This effect is exhibited even in a form in which hot air is irradiated only to the respective end portions 22, but the form in which hot air is irradiated to the entire coating film 20 is more remarkably exhibited. Specific examples of the laser include a fiber laser, a direct laser, and a VCSFL laser. The laser may be a laser having a high focusing property. Further, the irradiation frequency of the laser may be pulse irradiation or continuous irradiation with respect to the transport direction (see FIGS. 4A and 4B).

Thus, the drying step of one embodiment may be performed by combining a high energy density heat source and a low energy density heat source. The mechanism for simultaneously drying the coating film 20 by these heat sources is as follows. First, the central portion 21 can be dried by irradiating the central portion 21 of the coating film 20 with a heat source having a high energy density. Further, the respective end portions 22 can be dried by heat conduction from the central portion 21 to the respective end portions 22. Furthermore, by irradiating the respective end portions 22 with a heat source having a low energy density, the respective end portions 22 can be dried at the same time as the central portion 21 together with the residual heat from the central portion 21. As a result, the drying time of the central portion 21 and the respective end portions 22 of the coating film 20 can be adjusted to be the same.

Here, an equation for calculating the average energy density of the laser and the hot air is shown.

(Laser Mean Energy Density (W/cm²))=(Laser Energy Density (W/cm²))÷(Laser Irradiation Length in Transport Direction (mm))×(Drying-oven Total Length in Transport Direction (mm))

(Hot air average energy density (W/cm²))=(laser average energy density (W/cm²))×(time when the coating film is dried with only the laser (s))÷(time when the coating film is dried with only hot air(s))

The “time when the coating film is dried using only a laser” is the time when the coating film is dried by irradiating the entire coating film with only a laser. The “time when the coating film is dried using only hot air” is the time when the coating film is dried by irradiating only hot air to the entire coating film.

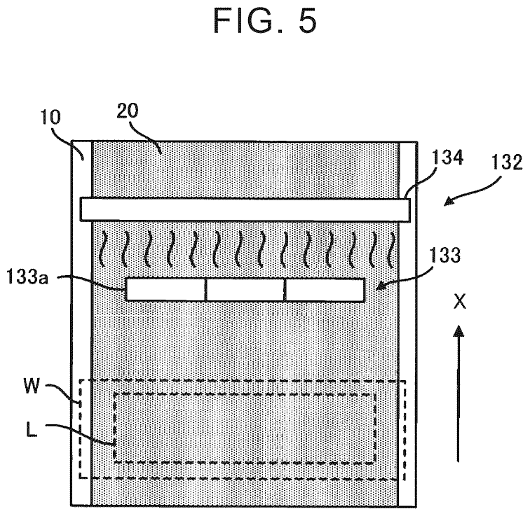

When the sum of the average energy densities of the heat sources applied to the central portion 21 of the coating film 20 is EC and the sum of the average energy densities of the heat sources applied to the end portions 22 of the coating film 20 is EE, EC/EE may be 1 or more and 4 or less. The reason why “the sum of the mean energy densities of the heat sources irradiated to the central portion 21 of the coating film 20 is EC” is that the central portion 21 of the coating film 20 may be irradiated with other heat sources in addition to the heat sources having a high energy density. For example, as shown in FIG. 5, which will be described later, the central portion 21 may be irradiated with a laser and hot air. EC is then the sum of the mean energy-density of the laser and hot air. The same applies to EE. That is, the end portion 22 of the coating film 20 may be irradiated with another heat source in addition to the heat source having a low energy density. This means that the end portion 22 is irradiated with a plurality of heat sources having a low energy density. For example, the end portion 22 may be irradiated with laser and hot air. EE is then the sum of the mean energy-density of the laser and hot air. Typically, however, the end portion 22 is irradiated with a single low energy density heat source.

When EC/EE is less than 1, the energy-density of the laser irradiated to the respective end portions 22 is too large, and the drying time of the end portions 22 becomes shorter than that of the central portion 21, and there is a possibility that cracking or peeling of the end portions cannot be suppressed. If EC/EE exceeds 4, the laser applied to the respective end portions 22 may be too low to dry the end portions 22. From the viewpoint of enhancing the effectiveness, EC/EE may be 2 or more and 4 or less.

Here, the coating film 20 will be further described. As described above, in addition to the irradiation of the low-energy-density heat source, the end portions 22 of the coating film 20 are dried by heat conduction from the central portion 21 irradiated with the high-energy-density heat source, and are dried simultaneously with the central portion 21. Thus, the extent of each end portion 22 is set to be dried simultaneously with the central portion 21, taking into account the mechanism described above. Therefore, the specific range of the end portion 22 of the coating film 20 is not particularly limited, and varies depending on the type and average energy density of the heat source having a high energy density and the heat source having a low energy density. For example, the end portion 22 of the coating film 20 may be an area from 3 to 18 mm from the start point toward the inside in the width direction (i.e., the width direction length of the end portion 22 of the coating film 20 may be 18 mm from 3) when the outermost end portion in the width direction of the coating film 20 is taken as the start point. Further, the end portion 22 of the coating film 20 may be an area from 5 to 18 mm from the start point toward the inside in the width direction (i.e., the width direction length of the end portion 22 of the coating film 20 may be 18 mm from 5).

Although the width direction length of the coating film 20 is not particularly limited, the drying step of one embodiment is suitable for the coating film 20 having a long width direction length. This is because the coating film 20 having a longer width direction length is more likely to cause drying unevenness. For example, the widthwise length of the coating film 20 may be greater than or equal to 1000 mm and less than or equal to 1500 mm.

Next, the heat source device 32 capable of performing the drying process of one embodiment will be described. The heat source device 32 can be realized by combining a high energy density heat source device capable of irradiating a high energy density heat source to the central portion 21 of the coating film 20 and a low energy density heat source device capable of irradiating each end portion 22 of the coating film 20 with a low energy density heat source.

FIG. 5 shows a heat source device 132 which is an example of the heat source device 32. The heat source device 132 is a combination of a laser irradiation device 133 which is a high energy density heat source device and a hot air irradiation device 134 which is a low energy density heat source device. As illustrated in FIG. 5, the laser irradiation device 133 includes a plurality of laser irradiation portions 133a arranged in a widthwise manner, and can irradiate the central portion 21 of the coating film 20 with a laser. The range indicated by L in FIG. 5 is the laser irradiation range. The number of the laser irradiation portions 133a is not particularly limited, and the entire width-direction of the central portion 21 may be set to the laser irradiation range. FIG. 5 illustrates a laser irradiation device 133 including three laser irradiators 133a. The hot air irradiation device 134 has a length equal to or longer than the length of the coating film 20 in the width direction, and is disposed over the width direction of the coating film 20. Then, the whole width direction of the coating film 20 can be irradiated with hot air. The range indicated by W in FIG. 5 is the hot air irradiation range. By using the heat source device 132 as described above, the drying process of one embodiment can be performed, and the drying time of the central portion and the end portion of the coating film 20 can be adjusted to be the same. Note that the hot air irradiation device 134 is not limited to a configuration in which the hot air irradiation device is disposed over the width direction of the coating film 20 as shown in FIG. 5, and may be disposed outside the laser irradiation device 233 in the width direction, and may be configured to irradiate the respective end portions 22 of the coating film 20 with hot air.

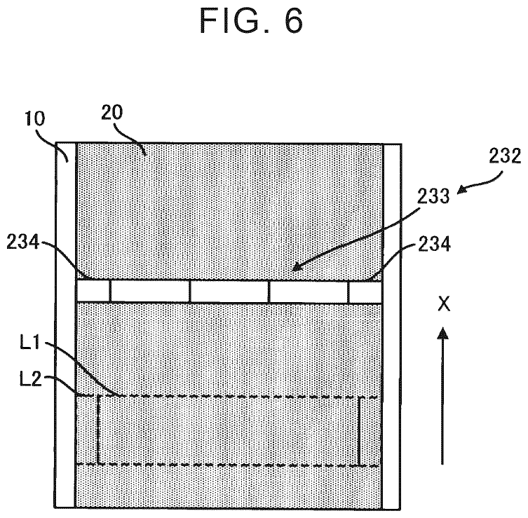

FIG. 6 shows a heat source device 232 which is another example of the heat source device 32. The heat source device 232 is a combination of a laser irradiation device (high-energy-density laser irradiation device) 233 which is a high-energy-density heat source device and laser irradiation devices (low-energy-density laser irradiation devices) 234 and 234 which are low-energy-density heat source devices. The average energy density of the laser irradiated from the high energy density laser irradiation device 233 is set higher than the average energy density of the laser irradiated from the low energy density laser irradiation devices 234 and 234. As shown in FIG. 6, the high energy density laser irradiation device 233 has a structure similar to that of the laser irradiation device 133 of FIG. 5. As shown in FIG. 6, the range indicated by L1 is the range irradiated by the high-energy-density laser. The low-energy-density laser irradiation devices 234 and 234 are respectively disposed outside the laser irradiation device 233 in the width direction, and can irradiate the entire width direction of each end portion 22 of the coating film 20 with the laser. As shown in FIG. 6, the range indicated by L2 is the range irradiated by the low-energy-density laser. In FIG. 6, the low energy density laser irradiation devices 234 and 234 include one laser irradiation unit, but the present disclosure is not limited to this configuration, and may include a plurality of laser irradiation units.

The electrode manufacturing method of the present disclosure has been described above with reference to one embodiment. According to the electrode manufacturing method of the present disclosure, peeling of the electrode from the current collector foil can be suppressed.

### A Battery Manufacturing Method

A battery manufacturing method of the present disclosure will be described using an embodiment.

One embodiment is a battery manufacturing method, comprising: an electrode manufacturing step of obtaining an electrode using the electrode manufacturing method; and a battery manufacturing step of assembling the battery using the electrode. Since the electrode manufacturing process has been described above, the battery manufacturing process will be described below.

The battery manufacturing step is a step of assembling the battery using the electrode obtained in the electrode manufacturing step. Such a battery manufacturing process is known. A typical example in which the electrode obtained in the electrode manufacturing step is a positive electrode will be described below, but the present disclosure is not limited thereto.

When the electrode obtained in the electrode manufacturing step is a positive electrode, a battery is manufactured using a separately manufactured negative electrode and an electrolyte layer.

When the electrolyte is a liquid-based electrolyte, a battery can be manufactured by disposing a separator between the positive electrode and the negative electrode, and then supplying the electrolyte to the separator. The separator is mainly a polyolefin-based porous sheet. The electrolyte solution is obtained by dissolving a supporting salt in a non-aqueous solvent. Examples of the non-aqueous solvent include carbonates, ethers, and esters. Examples of the support salt include LiPF₆, LiBF₄, lithium bis(fluorosulfonyl)imide (LiFSI), lithium bis(trifluoromethane)sulfonimide (LiTFSI), and the like.

When the electrolyte is a solid electrolyte, a battery can be manufactured by disposing a solid electrolyte layer between the positive electrode and the negative electrode. The solid electrolyte layer includes a solid electrolyte. The solid electrolyte layer may contain a binder. The solid electrolyte and the binder may be appropriately selected from the solid electrolyte and the binder described above.

The battery manufacturing method of the present disclosure has been described above with reference to one embodiment. In the battery manufacturing method of the present disclosure, since the electrode is manufactured based on the above-described electrode manufacturing method, the electrode is suppressed from being peeled from the current collector foil. Therefore, according to the battery manufacturing method of the present disclosure, it is possible to suppress deterioration in battery performance due to peeling of the electrode.

The relationship between the range of the end portion of the coating film and the dry residual moisture

After coating a slurry obtained by dispersing an electrode material in a solvent on a current collector foil to obtain a coating film, a current collector foil having a coating film formed thereon was introduced into a drying furnace, and the coating film was dried. The widthwise length of the coating was adjusted to 1160 mm.

The heat source apparatus of the drying furnace was constructed according to the configuration of FIG. 5. That is, a heat source apparatus in which a laser irradiation apparatus and a hot air irradiation apparatus are combined was used. The average energy density of the laser irradiated from the laser irradiation device was set to 0.44 W/cm². The average energy density of the hot air emitted from the hot air irradiator was set to 0.19 W/cm². From these numbers, EC/EE was calculated as 2.32. Further, the widthwise length of the hot air irradiator was 1160 mm.

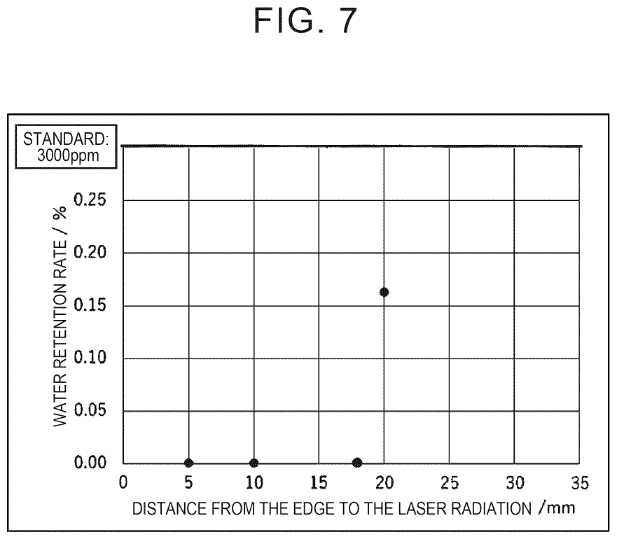

Here, 5 mm, 10 mm, 18 mm, 20 mm of the length in the width direction of the respective end portions of the coating film, that is, the water residual rate in the electrode end portions after being dried when the length in the width direction of the central portion of the coating film (the irradiated area of the laser) was changed to 1150 mm, 1140 mm, 1124 mm, 1120 mm was measured. Moisture retention was calculated from the weight ratio of the fragments before and after drying. The results are shown in FIG. 7.

As shown in FIG. 7, when the widthwise lengths of the respective end portions of the coating film were set to 5 mm, 10 mm or 18 mm, the water residual rate in the electrode end portions was 0%, and the electrode end portions were completely dried. On the other hand, when the widthwise length of the respective end portions of the coating film is set to 20 mm, the water residual rate in the end portions of the coating film was 0.16%, and the electrode edge was not completely dried. From this, it is considered desirable to set the widthwise length of the respective end portions of the coating film to be equal to or less than 18 mm.

### Relationship Between Coating Position and Drying Time

After coating a slurry obtained by dispersing an electrode material in a solvent on a current collector foil to obtain a coating film, a current collector foil having a coating film formed thereon was introduced into a drying furnace, and the coating film was dried. The widthwise length of the coating was adjusted to 1000 mm.

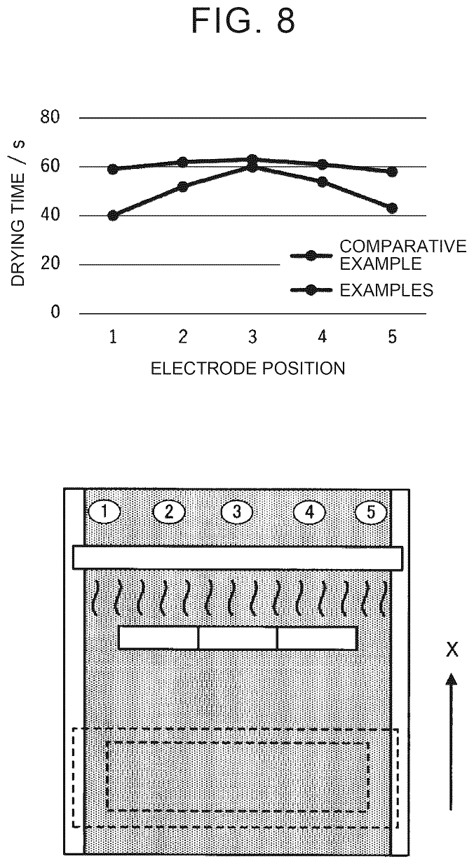

The heat source apparatus of the drying furnace was constructed according to the configuration of FIG. 8. That is, a heat source apparatus in which a laser irradiation apparatus and a hot air irradiation apparatus are combined was used. Then, the coating film was stopped at a predetermined position in a drying furnace, and then the coating film was dried using a laser and hot air.

The laser irradiation apparatus and the hot air irradiation apparatus used in Examples and Comparative Examples are as follows.

Example: A laser irradiator capable of irradiating a laser of laser mean energy density 1.2 W/cm²×width 960 mm was used. No laser irradiation was applied to the end. In addition, a hot air irradiator capable of irradiating hot air having a wind speed 10 m/s in the width 1100 mm was used.

Comparative example: A laser irradiator capable of irradiating a laser of laser average energy density 1.2 W/cm²×width 1100 mm was used. In addition, a hot air irradiator capable of irradiating hot air having a wind speed 10 m/s in the width 1100 mm was used.

The measurement parts 1 to 5 shown in FIG. 8 will be described. The measurement parts 1 and 5 are end portions of the coating film, and 2 to 4 are respective measurement positions when the central portion is divided into three portions. The drying time of each measurement site was measured from the temperature of the front surface and the back surface. The surface temperature was measured using a thermo-viewer. The back surface temperature was measured using a thermocouple. The results are shown in FIG. 8.

As shown in FIG. 8, in the comparative example, the drying time of the end portion was shorter than the drying time of the central portion, while in the example, the drying time of the central portion and the end portion was the same. From this result, it is considered that the drying time of the central portion and the end portion can be adjusted to the same by adjusting the average energy density of the heat source irradiated to the central portion and the end portion.

### Laser Energy Density Map

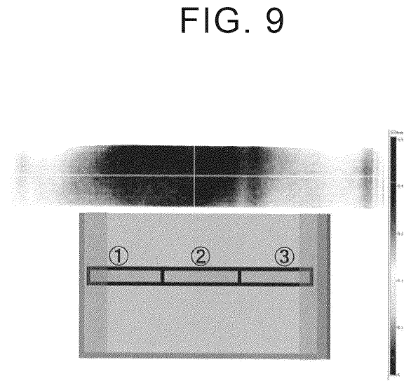

As shown in FIG. 9, three laser irradiation apparatuses 1 to 3 having different energy densities were installed. The radiation range of the respective laser irradiation devices was set to 400 mm. The average energy density of the laser irradiated from the laser irradiation apparatus is as follows.
Laser irradiator 1:1 W/cm²
Laser irradiator 2:2.5 W/cm²
Laser irradiator 3:1 W/cm²

The laser energy density map (temperature distribution) was obtained by irradiating each laser to a refractory block and measuring the block surface with a thermo-viewer. The results are shown in FIG. 9.

As shown in FIG. 9, the temperature of the portion irradiated to the laser irradiation device 2 was high, while the temperature of the portion irradiated to the laser irradiation devices 1 and 3 was low. From this result, it is considered that the drying time of the central portion and the end portion can be adjusted to the same by adjusting the average energy density of the heat source irradiated to the central portion and the end portion.

What is claimed is:

1. An electrode manufacturing method comprising:
an application step of applying slurry obtained by dispersing an electrode material in a solvent onto a current collector foil to obtain a coating film; and
a drying step of drying the coating film while transporting the current collector foil on which the coating film has been formed in a drying furnace, wherein:
the coating film has three regions divided along a transport direction, including a center portion disposed in a center in a width direction and end portions disposed on both sides of the center portion; and
the drying step includes drying each of the end portions of the coating film using a heat source having a low energy density, and drying the center portion of the coating film using a heat source having a high energy density.

2. The electrode manufacturing method according to claim 1, wherein the drying step includes using hot air or a laser as the heat source having a low energy density, and using a laser as the heat source having a high energy density.

3. The electrode manufacturing method according to claim 2, wherein
when a total of average energy densities of heat sources applied to the center portion of the coating film is EC and a total of average energy densities of heat sources applied to the end portions of the coating film is EE, EC/EE calculated based on the following equations is 1 or more and 4 or less:
(Laser average energy density (W/cm²))=(laser energy density (W/cm²))÷(length of laser irradiation in transport direction (mm))×(overall length of drying furnace in transport direction (mm))
(Hot air average energy density (W/cm²))=(laser average energy density (W/cm²))×(time for which coating film is dried with laser alone (s))÷(time for which coating film is dried with hot air alone (s)).

4. The electrode manufacturing method according to claim 1, wherein the end portions of the coating film are each an area that extends for 3 to 18 mm from a start point toward an inner side in the width direction, the start point being an extreme end portion of the coating film in the width direction.

5. The electrode manufacturing method according to claim 1, wherein a length of the coating film in the width direction is 1000 mm or more and 1500 mm or less.

6. A battery manufacturing method comprising:
an electrode fabrication step of obtaining an electrode using the electrode manufacturing method according to claim 1; and
a battery fabrication step of assembling a battery using the electrode.
